(19) United States
(12) Patent Application Publication
(10) Pub. No.: US 2022/0391265 A1
(43) Pub. Date: Dec. 8, 2022

(54) THREAD SYNCHRONIZATION APPARATUS, THREAD SYNCHRONIZATION METHOD, AND PROGRAM

(71) Applicant: NIPPON TELEGRAPH AND TELEPHONE CORPORATION, Tokyo (JP)

(72) Inventors: Kiyoaki MATSUI, Tokyo (JP); Yoshikazu YAMAGUCHI, Tokyo (JP)

(73) Assignee: NIPPON TELEGRAPH AND TELEPHONE CORPORATION, Tokyo (JP)

(21) Appl. No.: 17/782,645

(22) PCT Filed: Dec. 6, 2019
(86) PCT No.: PCT/JP2019/047789

§ 371 Date: Jun. 4, 2022

(51) Int. Cl. G06F 9/52; G06F 9/48; G10L 15/22

(52) U.S. Cl. CPC G06F 9/52; G06F 9/4881; G10L 15/22; G10L 2015/223

(57) ABSTRACT

Execution speed of a thread is dynamically restored while reducing influence on processing accuracy of the whole system. A thread synchronization device (10) achieves synchronization among N threads (1-1, . . . , 1-N) to perform parallel processing by dividing time-series data into a plurality of pieces of data. Environment variables which achieve a trade-off between processing accuracy and execution speed are individually set at the threads (1-1, . . . , 1-N). An execution speed calculation unit (2) calculates execution speed of each of the threads. An environment variable update unit (3) updates the environment variables in accordance with the execution speed of the threads.

### TECHNICAL FIELD

The present invention relates to a technique of executing a plurality of threads in synchronization with each other.

### BACKGROUND ART

There is a case where it is desired to perform processing on one certain input while achieving synchronization among a plurality of threads. For example, in a case where speech of dialogue speech is recognized among a plurality of speakers, there is a case where the dialogue speech is divided into channels for each speaker and the respective channels are processed with different threads. In this event, it is necessary to align a processing position among all the threads to maintain context relationship of speech. Further, for example, Patent Literature 1 discloses a technique of obtaining speaker arrangement information using a synchronization word when audio data of a multichannel is downmixed.

### CITATION LIST

### Patent Literature

Patent Literature 1: Japanese Patent Laid-Open No. 2018-116313

### SUMMARY OF THE INVENTION

### Technical Problem

Normally, in a case where synchronization processing is performed, a method is used in which a thread which is advanced at a certain timing waits for processing of a thread which is delayed, and processing is restarted when delay is dissolved. However, with this method, execution speed of the whole system is determined by the latest thread, which causes a problem that in a case were execution speed of one of the threads decreases, for example, due to increase in CPU utilization, degradation of throughput, or the like, the execution speed of the whole system becomes lower.

In view of the technical problem as described above, an object of the present invention is to provide a technique of, in a case where execution speed of a specific thread decreases, enabling the execution speed of the thread to be dynamically restored while maintaining synchronization among a plurality of threads and reducing influence on processing accuracy of the whole system.

### Means for Solving the Problem

To solve the above-described problem, a thread synchronization device according to one aspect of the present invention is a thread synchronization device which achieves synchronization among a plurality of threads to perform parallel processing by dividing time-series data into a plurality of pieces of data, environment variables which achieve a trade-off between processing accuracy and execution speed being individually set at the threads, the thread synchronization device including an execution speed calculation unit configured to calculate execution speed of each of the threads, and an environment variable update unit configured to update the environment variables in accordance with the execution speed of the threads.

### Effects of the Invention

According to the present invention, in a case where execution speed of a specific thread decreases, it is possible to dynamically restore the execution speed of the thread while maintaining synchronization among a plurality of threads and reducing influence on processing accuracy of the whole system.

### BRIEF DESCRIPTION OF DRAWINGS

FIG. 1 is a view illustrating an example of a functional configuration of a thread synchronization device.

FIG. 2 is a view illustrating an example of processing procedure of a thread synchronization method.

FIG. 3 is a view illustrating an example of a functional configuration of a computer.

### DESCRIPTION OF EMBODIMENTS

An embodiment of the present invention will be described in detail below. Note that the same reference numerals will be assigned to components having the same functions in the drawings, and redundant description will be omitted.

### EMBODIMENT

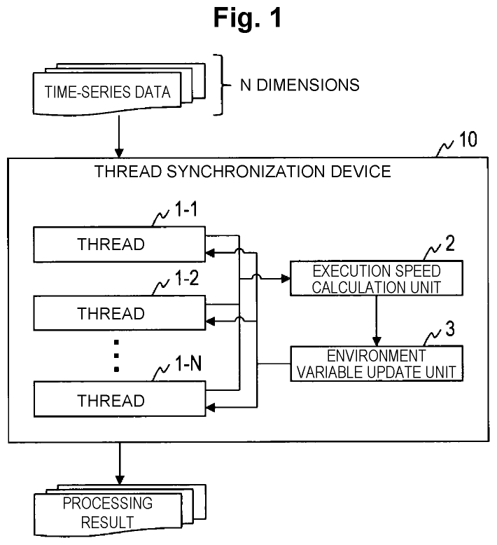

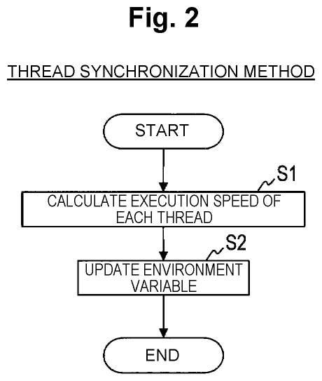

As illustrated in FIG. 1, a thread synchronization device 10 of an embodiment is a signal processing device which receives input of time-series data of N dimensions, executes predetermined processing on the input time-series data in parallel while achieving synchronization among N threads and outputs the processing results. The thread synchronization device 10 includes N threads 1-1, . . . , 1-N (where N≥2), an execution speed calculation unit 2, and an environment variable update unit 3. A thread synchronization method of the embodiment is achieved by this thread synchronization device 10 performing processing in respective steps illustrated in FIG. 2.

The thread synchronization device 10 is, for example, a special device which is constituted by a special program being loaded to a publicly known or dedicated computer which includes a central processing unit (CPU), a random access memory (RAM), or the like. The thread synchronization device 10, for example, executes respective kinds of processing under control by the CPU. Data input to the thread synchronization device 10 and data obtained through the respective kinds of processing are, for example, stored in the RAM, and the data stored in the RAM is read out to the CPU as necessary and utilized for other processing. At least part of the respective processing units of the thread synchronization device 10 may be constituted with hardware such as an integrated circuit.

Environment variables which achieve a trade-off between processing accuracy and execution speed are set at the thread synchronization device 10. The environment variables are individually defined for the respective threads 1-1, . . . , 1-N. Hereinafter, an environment variable of an i-th (where i=1, N) thread will be described as Envᵢ. The environment variables are different depending on processing content to be performed on the input time-series data. For example, in a case of speech recognition processing which will be described later, the number of higher-order hypotheses which are to be held in hypothesis search can be used as the environment variable.

Processing procedure of the thread synchronization method to be executed by the thread synchronization device 10 of the embodiment will be described with reference to FIG. 2.

In step S1, the execution speed calculation unit 2 calculates execution speed of each of the threads 1-1, . . . , 1-N. The execution speed may be calculated using any method. For example, it is only necessary to use a value obtained by dividing a time length of processed data by a period required for processing. The execution speed may be calculated on the thread side or may be calculated on the execution speed calculation unit side. In the former case, each thread transmits the calculated execution speed to the execution speed calculation unit 2. In the latter case, each thread transmits information (for example, the time length of the processed data and the period required for processing) necessary for calculating execution speed to the execution speed calculation unit 2, and the execution speed calculation unit 2 calculates execution speed of each thread. Hereinafter, execution speed of i-th (where i=1, . . . , N) thread will be described as RTFᵢ. The execution speed calculation unit 2 outputs the calculated execution speed RTF₁, . . . , RTF_{N} of the respective threads 1-1, . . . , 1-N to the environment variable update unit 3.

In step S2, the environment variable update unit 3 receives the execution speed RTF₁, . . . , RTF_{N} of the respective threads 1-1, . . . , 1-N from the execution speed calculation unit 2 and updates an environment variable ENVᵢ of the thread 1-i for each i in accordance with the execution speed RTFᵢ.

Specific algorithm upon update of the environment variables will be described below.

# value from data
Real Time Factor of each thread: RTF₁ to RTF_{N}
Amount of processed data: N₁ to N_{N}
The maximum value of processed sample: N_{MAX} = max_{1≤n≤N}Nₙ
# parameter
Threshold of RTF: Thr_{RTF}
Threshold of processed sample: Thrₛₐₘₚₗₑ
The maximum value of Env: Env_{MAX}
The minimum value of Env: Envₘᵢₙ
Change ratio: ratio
# main

| | |
|---|---|
| 1: | for i in 1 to N: |
| 2: | if (countᵢ > T_{cooltime}): |
| 3: | if ((RTFᵢ > Thr_{RTF}) and (\|N_{MAX}-Nᵢ\| > Thrₛₐₘₚₗₑ)): |
| 4: | if (Envᵢ/ratio ≥ Envₘᵢₙ): |
| 5: | Envᵢ = Envᵢ/ratio |
| 6: | else: |
| 7: | if (Envᵢ*ratio ≤ Env_{MAX}): |
| 8: | Envᵢ = Envᵢ*ratio |
| 9: | countᵢ = 0 |
| 10: | else: |
| 11: | countᵢ += 1 |

The above-described algorithm will be described. RTF₁ to RTF_{N} are respectively execution speed (real time factor: RTF) of the respective threads 1-1, . . . , 1-N. N₁ to N_{N} are the number of processed samples of the respective threads 1-1, . . . , 1-N. N_{MAX} is the number of processed samples of a thread for which processing is most advanced. The environment variable update unit 3 first determines whether or not the “execution speed (RTFᵢ)” of each thread and a “difference (|N_{MAX}−Nᵢ|) between the number of processed samples N_{MAX} of a thread for which processing is most advanced and the number of processed samples Nᵢ of the own thread” exceed respective thresholds (Thr_{RTF}, Thrₛₐₘₚₗₑ) (third line). It is assumed that the respective thresholds Thr_{RTF} and Thrₛₐₘₚₗₑ are set in advance. If one of the execution speed and the difference exceeds the threshold, the environment variable update unit 3 decreases the environment variable Envᵢ of the thread by dividing the environment variable Envᵢ by a predetermined ratio (fifth line). However, the updated value cannot fall below a lower limit Envₘᵢₙ of the environment variable (fourth line). Inversely, if both the execution speed and the difference are equal to or less than the thresholds, the environment variable update unit 3 increases the environment variable Envᵢ by multiplying the environment variable Envᵢ by a predetermined ratio (eighth line). However, the updated value cannot exceed an upper limit value Envₘₐₓ of the environment variable (seventh line). The environment variable update unit 3 performs control not to change the environment variable until a predetermined period T_{cooltime} elapses in a case where the above-described operation is performed once, to prevent excessive fluctuation of the environment variable (second line). Note that while the value is updated through division and multiplication assuming that the predetermined ratio is a value exceeding 1 in the above-described algorithm, the value may be updated using any method if the value can decrease or increase in a stepwise manner.

### EXAMPLE

The present invention can be applied to overall recognition processing to be performed on time-series data having N dimensions. While a hypothesis which is most likely to occur is searched for in recognition task, it is typical to search only some higher-order hypotheses instead of searching all possible hypotheses to make processing more efficient. In this event, it is typical to hold “how many hypotheses are to be held” as the environment variable. This can be used as an “environment variable which achieves a trade-off between processing accuracy and execution speed”.

An example of speech recognition task will be described below as one of the examples.

In a case where multi-channel speech such as speech at a meeting and conversation between a customer and an operator at a call center is continuously recognized, there is a case where it is desired to divide speech data in channel unit and perform recognition at the same time while achieving synchronization among the channels. In this case, typically, frames are cut for each of several tens of milliseconds in chronological order and sequentially processed. In this event, a difference in execution speed among the respective threads occur as a difference in processing speed among the channels. In hypothesis search in speech recognition, a beam width which represents how many higher-order hypotheses are to be held can be held as the environment variable. This beam width can be dealt with as the “environment variable which achieves a trade-off between processing accuracy and execution speed” in speech recognition. Setting of such conditions enables the present invention to be applied to the speech recognition task.

The present invention can achieve synchronization in execution speed among threads while minimizing influence on processing accuracy of a system by changing the environment variable which achieves a trade-off between processing accuracy and execution speed in a stepwise manner and monitoring influence of the change. Further, in a case where execution speed of a thread which is delayed is improved and there is no difference in execution speed among the threads, the environment variable can be restored in a stepwise manner to maintain processing accuracy. By this means, in a case where execution speed of a specific thread decreases, it is possible to dynamically restore the execution speed of the thread while maintaining synchronization among a plurality of threads and minimizing influence of the thread on processing accuracy.

While the embodiment of the present invention has been described above, it goes without saying that a specific configuration is not limited to the embodiment, and change, or the like, of design which is made as appropriate within a range not deviating from the gist of the present invention is incorporated into the present invention. Various kinds of processing described in the embodiment may be executed in parallel or individually in accordance with processing performance of devices which execute the processing or as appropriate as well as being executed in chronological order in accordance with order of the description.

[Program, Recording Medium]

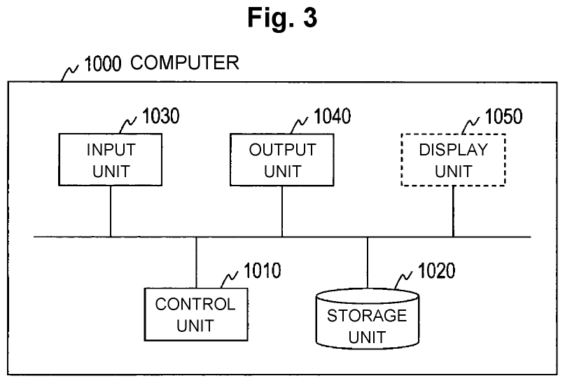

In a case where various kinds of processing functions at the respective devices described in the above-described embodiment are implemented with a computer, processing content of functions which should be provided at respective devices is described with a program. Further, the various kinds of processing functions at the above-described respective devices are implemented on the computer by the program being loaded to a storage unit 1020 of the computer illustrated in FIG. 3 and being performed by a control unit 1010, an input unit 1030, an output unit 1040, or the like.

The program describing this processing content can be recorded in a computer-readable recording medium. Any medium such as a magnetic recording device, an optical disk, a magnetooptical recording medium and a semiconductor memory can be used as the computer-readable recoding medium.

Further, this program is distributed by, for example, a portable recording medium such as a DVD and a CD-ROM in which the program is recorded being sold, given, lent, or the like. Still further, it is also possible to employ a configuration where this program is distributed by the program being stored in a storage device of a server computer and transferred from the server computer to other computers via a network.

A computer which executes such a program, for example, first, stores a program recorded in the portable recording medium or a program transferred from the server computer in the storage device of the own computer once. Then, upon execution of the processing, this computer reads the program stored in the storage device of the own computer and executes the processing in accordance with the read program. Further, as another execution form of this program, the computer may directly read a program from the portable recording medium and execute the processing in accordance with the program, and, further, sequentially execute the processing in accordance with the received program every time the program is transferred from the server computer to this computer. Further, it is also possible to employ a configuration where the above-described processing is executed by so-called application service provider (ASP) type service which implements processing functions only by instruction of execution and acquisition of a result without the program being transferred from the server computer to this computer. Note that, it is assumed that the program in this form includes information which is to be used for processing by an electronic computer, and which is equivalent to a program (not a direct command to the computer, but data, or the like, having property specifying processing of the computer).

Further, while, in this form, the present device is constituted by a predetermined program being executed on the computer, at least part of the processing content may be implemented with hardware.

1. A thread synchronization device for synchronizing a plurality of threads to perform parallel processing, the device comprising a processor configured to execute a method comprising:
calculating execution speed of each of the plurality of threads;
updating environment variables in accordance with the execution speed of the plurality of threads, wherein the environment variables describe a trade-off between processing accuracy and execution speed associated with the plurality of threads, and wherein the environment variables are individually set at each of the plurality of threads; and
dividing time-series data into a plurality of pieces of data for parallel processing based on the plurality of threads according to the environment variables.

2. The thread synchronization device according to claim 1,
wherein the updating comprises:
calculating a difference in execution speed between a thread for which the execution speed is the highest and respective threads of the plurality of threads,
in a case where the difference in the execution speed exceeds a predetermined threshold, updating the environment variables of the plurality of threads so as to improve execution speed, and
in a case where the difference in the execution speed is equal to or less than the predetermined threshold, updating the environment variables of the plurality of threads so as to improve processing accuracy.

3. The thread synchronization device according to claim 2,
wherein processing accuracy becomes higher as a value of the environment variables is greater, and execution speed becomes higher as the value is smaller, and
the updating further comprises:
dividing the environment variables of the plurality of threads by a ratio greater than 1 determined in advance in a case where the difference in the execution speed exceeds the predetermined threshold, and
multiplying the environment variables of the plurality of threads by the ratio in a case where the difference in the execution speed is equal to or less than the predetermined threshold.

4. The thread synchronization device according to claim 1,
wherein the plurality of threads at least in part perform speech recognition for each channel of a speech signal, and
a number of higher-order hypotheses to be held in hypothesis search of speech recognition is set as the environment variables.

5. A thread synchronization method for synchronizing a plurality of threads to perform parallel processing,
the method comprising:
calculating execution speed of each of the plurality of threads;
updating the environment variables in accordance with the execution speed of the plurality of threads, wherein the environment variables describe a trade-off between processing accuracy and execution speed associated with the plurality of threads, and wherein the environment variables are individually set at each of the plurality of threads; and
dividing time-series data into a plurality of pieces of data for parallel processing based on the plurality of threads according to the environment variables.

6. A computer-readable non-transitory recording medium storing computer-executable program instructions that when executed by a processor cause a computer to execute a method comprising:
calculating execution speed of each of a plurality of threads;
updating environment variables in accordance with the execution speed of the plurality of threads, wherein the environment variables describe a trade-off between processing accuracy and execution speed associated with the plurality of threads, and wherein the environment variables are individually set at each of the plurality of threads; and
dividing time-series data into a plurality of pieces of data for parallel processing based on the plurality of threads according to the environment variables.

7. The thread synchronization device according to claim 2,
wherein the plurality of threads at least in part perform speech recognition for each channel of a speech signal, and
a number of higher-order hypotheses to be held in hypothesis search of speech recognition is set as the environment variables.

8. The thread synchronization device according to claim 3,
wherein the plurality of thread at least in part perform speech recognition for each channel of a speech signal, and
a number of higher-order hypotheses to be held in hypothesis search of speech recognition is set as the environment variables.

9. The thread synchronization method according to claim 5, wherein the updating comprises:
calculating a difference in execution speed between a thread for which the execution speed is the highest and the respective threads of the plurality of threads,
in a case where the difference in the execution speed exceeds a predetermined threshold, updating the environment variables of the plurality of threads so as to improve execution speed, and
in a case where the difference in the execution speed is equal to or less than the predetermined threshold, updating the environment variables of the plurality of threads so as to improve processing accuracy.

10. The thread synchronization method according to claim 9, wherein processing accuracy becomes higher as a value of the environment variables is greater, and execution speed becomes higher as the value is smaller, and
the updating further comprises:
dividing the environment variables of the plurality of threads by a ratio greater than 1 determined in advance in a case where the difference in the execution speed exceeds the predetermined threshold, and
multiplying the environment variables of the plurality of threads by the ratio in a case where the difference in the execution speed is equal to or less than the predetermined threshold.

11. The thread synchronization method according to claim 5, wherein the plurality of threads at least in part perform speech recognition for each channel of a speech signal, and
a number of higher-order hypotheses to be held in hypothesis search of speech recognition is set as the environment variables.

12. The thread synchronization method according to claim 9, wherein the plurality of threads at least in part perform speech recognition for each channel of a speech signal, and
a number of higher-order hypotheses to be held in hypothesis search of speech recognition is set as the environment variables.

13. The thread synchronization method according to claim 10, wherein the plurality of threads at least in part perform speech recognition for each channel of a speech signal, and
a number of higher-order hypotheses to be held in hypothesis search of speech recognition is set as the environment variables.

14. The computer-readable non-transitory recording medium according to claim 6, wherein the updating comprises:
calculating a difference in execution speed between a thread for which the execution speed is the highest and the respective threads of the plurality of threads,
in a case where the difference in the execution speed exceeds a predetermined threshold, updating the environment variables of the plurality of threads so as to improve execution speed, and
in a case where the difference in the execution speed is equal to or less than the predetermined threshold, updating the environment variables of the plurality of threads so as to improve processing accuracy.

15. The computer-readable non-transitory recording medium according to claim 14, wherein processing accuracy becomes higher as a value of the environment variables is greater, and execution speed becomes higher as the value is smaller, and
the updating further comprises:
dividing the environment variables of the plurality of threads by a ratio greater than 1 determined in advance in a case where the difference in the execution speed exceeds the predetermined threshold, and
multiplying the environment variables of the plurality of threads by the ratio in a case where the difference in the execution speed is equal to or less than the predetermined threshold.

16. The computer-readable non-transitory recording medium according to claim 6, wherein the plurality of threads at least in part perform speech recognition for each channel of a speech signal, and
a number of higher-order hypotheses to be held in hypothesis search of speech recognition is set as the environment variables.

17. The computer-readable non-transitory recording medium according to claim 14, wherein the plurality of threads at least in part perform speech recognition for each channel of a speech signal, and
a number of higher-order hypotheses to be held in hypothesis search of speech recognition is set as the environment variables.

18. The computer-readable non-transitory recording medium according to claim 15, wherein the plurality of threads at least in part perform speech recognition for each channel of a speech signal, and
a number of higher-order hypotheses to be held in hypothesis search of speech recognition is set as the environment variables.
